(19) United States
(12) Patent Application Publication
(10) Pub. No.: US 2004/0168195 A1
(43) Pub. Date: Aug. 26, 2004

(54) Digital broadcasting system and operating method thereof

(75) Inventor: Chang Sup Lee, Seoul (KR)

Correspondence Address: JONATHAN Y. KANG, ESQ., LEE, HONG, DEGERMAN, KANG & SCHMADEKA, 14th Floor, 801 S. Figueroa Street, Los Angeles, CA, 90017-5554, US

(73) Assignee: LG Electronics Inc.

(21) Appl. No.: 10/783,257

(22) Filed: Feb. 19, 2004

(30) Foreign Application Priority Data
Feb. 21, 2003 (KR) 10962/2003

(51) Int. Cl. H04N 7/173; H04N 7/16

(52) U.S. Cl. 725/110; 725/112; 725/109; 725/135

(57) ABSTRACT

The present invention relates to a digital broadcasting system and an operating method thereof. The digital broadcasting system including: a transmitting unit having a unit for generating digital broadcast including audio/video broadcast and data broadcast, and a unit for registering the digital broadcast or the data broadcast on a certain internet site; and an internet terminal connecting to the internet site to receive the digital broadcast or the data broadcast. The method for operating digital broadcast at a transmitting unit of a digital broadcast system, the method including the steps of: producing data broadcast; generating the digital broadcast by using the data broadcast and audio/video broadcast; and registering the produced data broadcast or the produced digital broadcast on a certain internet site, wherein the produced data broadcast or the generated digital broadcast is provided depending on a viewer's request.

### BACKGROUND OF THE INVENTION

1. Field of the Invention

The present invention relates to a digital broadcasting system, and more particularly, to a digital broadcasting system and an operating method thereof in which digital broadcast or data broadcast can be viewed using internet.

2. Description of the Related Art

A modern society has been entering an information age owing to a development of an information communication field resulting from a digital revolution and a great development of an electronic industry and internet. Accordingly, as conventional information diffusion through a simple contact is changed into information diffusion through a wire/wireless intermediate, necessary information is allowed to be provided in real time.

Further, television broadcasting is in progress of being rapidly digitalized, and accordingly, a digital television is used as gigantic and effective information storage media and information providing media.

Generally, the digital television is a common term of digital-transmitted television broadcasting. America decided the transmission of a next generation television called an ATV (Advanced Television) as digital transmission. In Europe, many projects are vigorously being advanced, such as HD DIVINE in Sweden, SPECTRE in England, DIAMOND in France and the like. The digital broadcast, as a next generation manner associated with B-ISDN (Broadband Integrated Services Digital Network) or a computer network, has been vigorously studied in each of countries.

In the meanwhile, stream transmitted in the digital broadcasting enables to transmit data information together with video/audio signals. Herein, data information may be made on the basis of markup, such as HTML (hypertext markup language) of ATVEF (Advanced Television Enhancement Forum) XDML (Extensible Document Markup Language) of DASE (Digital TV Application Software Environment) or on the basis of Java such as Xlet of the DASE.

At present, a number of companies have been developing the digital television or the settop box capable of receiving the digital broadcast or the data broadcast so as to prepare for digital broadcasting. In the future, a field related with data broadcasting is expected to most come into the spotlight when the digital television is generalized.

The digital broadcasting provides the viewer with the data broadcast including various additional information as well as a high-definition and high-quality AV (audio/video) broadcast.

To view the digital broadcast described above, the viewer has to have the settop box or the digital television for the digital broadcast.

However, the settop box or the digital television for the digital broadcast is a large obstacle owing to its high price in activating the supply of the data broadcasting to develop contents and to create added-value.

Further, there is a drawback in that time and place are limited since the viewer has to have the settop box or the digital television for the digital broadcast so as to view the digital broadcast or the data broadcast.

### SUMMARY OF THE INVENTION

Accordingly, the present invention is directed to a digital broadcasting system and an operating method thereof that substantially obviate one or more problems due to limitations and disadvantages of the related art.

An object of the present invention is to provide a digital broadcasting system and an operating method thereof in which digital broadcast or data broadcast can be viewed using internet irrespective of time and place.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a digital broadcasting system including: a transmitting unit having a unit for generating digital broadcast including audio/video broadcast and data broadcast, and a unit for registering the digital broadcast or the data broadcast on a certain internet site; and an internet terminal connecting to the internet site to receive the digital broadcast or the data broadcast.

The internet terminal can have a browser embedded therein for allowing connection to the internet site.

The internet site stores digital broadcast or the data broadcast continuously produced.

According to the digital broadcasting system, it can further include a unit for converting the digital broadcast and the data broadcast into an internet-supporting format in case that the digital broadcast or the data broadcast is not in the internet-supporting format.

In another aspect of the present invention, there is provided a method for operating digital broadcast at a transmitting unit of a digital broadcast system, the method including the steps of: producing data broadcast; generating the digital broadcast by using the data broadcast and audio/video broadcast; and registering the produced data broadcast or the produced digital broadcast on a certain internet site, wherein the produced data broadcast or the generated digital broadcast is provided depending on a viewer's request.

According to the operating method, it can further include the step of converting the generated digital broadcast and the produced data broadcast into an internet-supporting format in case that the generated digital broadcast and the produced data broadcast is not in the internet-supporting format.

In a further aspect of the present invention, there is provided a method for operating digital broadcast at an internet terminal of a digital broadcasting system, the method including the steps of: connecting to an internet site providing digital broadcast or data broadcast; selecting broadcast that is intended to be viewed; and downloading and displaying the selected broadcast.

According to the operating method, it can further include the step of downloading and installing a dedicated browser in case that the dedicated browser exists in the internet site.

According to the operating method, in case that a linked internet site exists among the displayed broadcasts, a viewer can move to the linked internet site depending on his/her request.

According to the operating method, various data broadcasts provided from the internet site can be concurrently displayed in addition to the displayed broadcast.

In a further another aspect of the present invention, there is provided a method for operating a digital broadcasting system, the method including the steps of: registering digital broadcast or data broadcast on a certain internet site; connecting to the internet site to select broadcast that is intended to be viewed; and downloading and displaying the selected broadcast.

The data broadcast may have a linked internet site.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic block diagram illustrating a general construction of a digital broadcasting system according to a preferred embodiment of the present invention;

FIG. 2 is a flow chart illustrating a method for operating a digital broadcast in a transmitting unit of a digital broadcast system according to a preferred embodiment of the present invention; and

FIG. 3 is a flow chart illustrating a method for operating a digital broadcast in a receiving unit of a digital broadcasting system according to a preferred embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

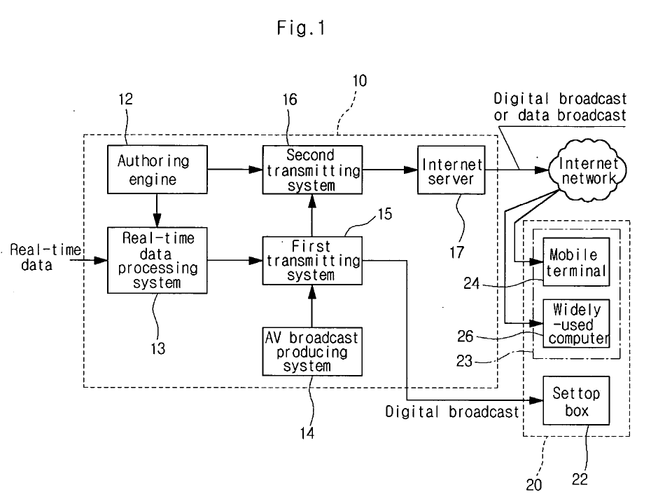

FIG. 1 is a schematic block diagram illustrating a general construction of a digital broadcasting system according to a preferred embodiment of the present invention.

Referring to FIG. 1, the inventive digital broadcasting system includes a transmitting unit 10 for providing a digital broadcast or a data broadcast; and a receiving unit 20 for viewing the digital broadcast or the data broadcast.

The transmitting unit 10 includes an authoring engine 12, a real-time data processing system 13, an AV (Audio/Video) broadcast producing system 14, a first transmitting system 15, a second transmitting system 16, and an internet server 17.

The authoring engine 12 uses data broadcast contents to produce the data broadcast. That is, a producer can receive the data broadcast contents from a provider for providing the data broadcast contents, or from other businessmen or the like. The producer produces the data broadcast on the basis of the provided data broadcast contents using the authoring engine 12. Herein, the data broadcast can be produced on the basis of Markup such as HTML or XDML or on the basis of Java such as Xlet.

The above-produced data broadcast is provided for the real-time data processing system 13 and the second transmitting system 16.

The AV broadcast producing system 14 is a system for producing AV broadcast, and for example, can produce the AV broadcast for drama, sports, amusement, documentary and the like. The above-produced AV broadcast is provided for the first transmitting system 15.

The real-time data processing system 13 uses the data broadcast produced from the authoring engine 12 and real-time data provided from an external to constitute certain data broadcasting.

The first transmitting system 15 generates and transmits the digital broadcast including the data broadcast provided from the real-time data processing system 13 and the AV broadcast provided from the AV broadcast producing system 14. The above transmitted digital broadcast can be provided for the viewer using ground wave, satellite, cable and the like.

The second transmitting system 16 constructs the data broadcast provided from the authoring engine 12 or the digital broadcast provided from the first transmitting system 15 to be served on internet such that the constructed broadcast is provided for the internet server 17.

The internet server 17 registers the digital broadcast or the data broadcast on a certain internet site. Accordingly, the viewer can connect to the internet site to view the digital broadcast or the data broadcast.

In the meanwhile, the receiving unit 20 is comprised of a settop box 22 or a digital television for receiving the digital broadcast provided using the ground wave, the satellite, the cable and the like from the first transmitting system 15; and an internet terminal 23 such as a mobile terminal 24 or a widely used computer 26 connecting to the internet server 17 to receive the digital broadcast or the data broadcast. Herein, the internet terminal 23 can additionally include a PDA (Portable digital Assistant), electric home appliances with an internet function, a portable computer, a personal terminal and the like.

The settop box 22 or the digital television is a unit for receiving the digital broadcast or the data broadcast, and is a product that is already in progress of a widely commercial use.

The internet terminal 23 can use the internet site to connect to the internet server 17, thereby receiving the digital broadcast or the data broadcast. The internet terminal 23 should include hardware (for example, modem, ADSL and the like) and software (for example, browser) to support internet service. Particularly, as a browser, a dedicated browser provided at the internet server 17 or a widely used browser embedded in the internet terminal 23 such as the mobile terminal 24 or the widely used computer 26 can be used.

The viewer can connect to the internet server 17 so that the dedicated browser can be downloaded and installed in the internet terminal 23.

Accordingly, the viewer can connect to the internet server 17 through the dedicated browser or the widely used browser. According to need, the digital broadcast (including all of the AV broadcast and the data broadcast) or the data broadcast can be downloaded for viewing. In order to listen or view the AV broadcast, the internet terminal 23 may include a display unit, a speaker or the like.

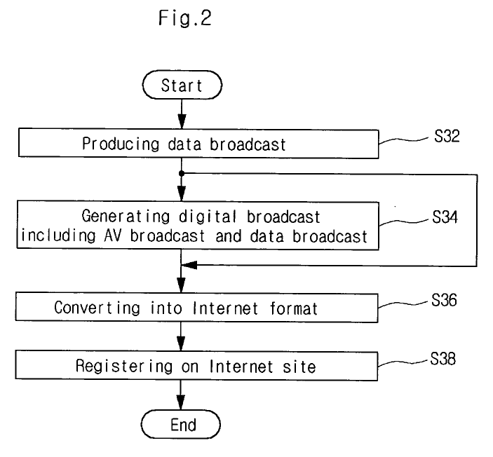

FIG. 2 is a flow chart illustrating a method for operating the digital broadcast in the transmitting unit of the digital broadcasting system according to a preferred embodiment of the present invention.

Referring to FIG. 2, first of all, the data broadcast contents are used to produce the data broadcast (S32). The producer uses the authoring engine 12 to produce the data broadcast on the basis of the data broadcast contents. Herein, the data broadcast can be produced based on Markup such as HTML or XDML, or can be produced based on Java such as Xlet. Similarly, since the data broadcast is produced based on Markup or Java, it can be also used for the internet service.

The digital broadcast including the above-produced data broadcast and AV broadcast is generated (S34). Accordingly, the digital broadcast includes the data broadcast as well as the AV broadcast. Generally, the above-generated digital broadcast is transmitted through sky wave, wire, cable and the like, and the viewer uses the settop box or the digital television to receive and view the digital broadcast.

The present invention can not only transmit the digital broadcast using the sky wave and the like, but also can provide the viewer with the digital broadcast through internet.

In other words, the digital broadcast generated in the step (S34) is converted into an internet format to be constructed for enabling the internet service. Further, the data broadcast that could not be transmitted using the sky wave and the like can be also converted into the internet format to be provided for the viewer.

If the data broadcast is not produced based on Markup or Java, the data broadcast can be converted into the internet format based on Markup or Java.

In the digital broadcast, the AV broadcast is converted into an image file, and the data broadcast can be converted into the internet format based on Markup or Java in case of not being in the internet format.

In other words, the digital broadcast generated in the step (S34) or the data broadcast produced in the step (S32) is converted into the internet format (S36).

Next, the digital broadcast or the data broadcast converted into the internet format is registered on the certain internet site (S38).

Accordingly, the viewer can connect to the internet site to view the digital broadcast or the data broadcast.

At this time, the internet site can provide the dedicated browser that can allow a dedicated connection.

If the internet site does not provide the dedicated browser, the viewer can use the widely used browser embedded in the internet terminal 23 of himself/herself to connect to the internet site.

The data broadcast or the digital broadcast continuously produced is stored in the internet site within an allowable range of capacity. Accordingly, the viewer can view past digital broadcast or data broadcast as well as present digital broadcast or data broadcast.

Further, since the data broadcasts different from one another are registered on the internet site, the viewer can also concurrently view the different data broadcasts from one another on one screen according to need.

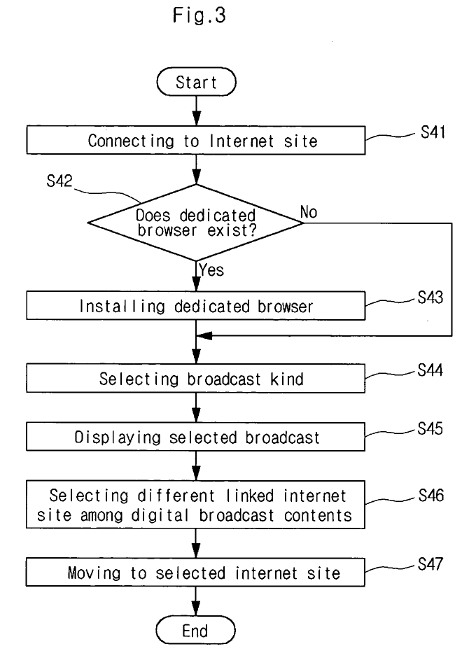

FIG. 3 is a flow chart illustrating a method for operating the digital broadcast in the receiving unit of the digital broadcasting system according to a preferred embodiment of the present invention.

Referring to FIG. 3, the viewer first uses the widely used browser embedded in the internet terminal 23 to connect to the internet site having the digital broadcast or the data broadcast registered thereon (S41).

At this time, if the dedicated browser exists in the internet site (S42), the dedicated browser is downloaded to be installed at the viewer's internet terminal 23 (S43).

If the dedicated browser does not exist in the internet site, the widely used browser embedded in the internet terminal 23 can be used for connection to the internet site.

If the dedicated browser is installed at the internet terminal 23, the viewer can terminate the widely used browser used for connection to the internet site and use the dedicated browser installed at the internet terminal 23 to connect to the internet site.

If the viewer connects to the internet site as described above, the viewer refers to various kinds of broadcasts registered on the internet site to select the broadcast which he/she intends to view (S44). Herein, as the broadcast kind, the digital broadcast and the data broadcast can be included. Herein, the digital broadcast includes the data broadcast as well as the AV broadcast.

If the viewer selects the broadcast, the selected broadcast is downloaded and displayed (S45). Accordingly, the viewer can view his/her selecting broadcast.

For example, if the viewer selects the digital broadcast, the data broadcast as well as the AV broadcast is displayed. Herein, the data broadcast can be also information relating with the AV broadcast or can be also other additional information, for example, shopping, game, amusement, advertisement and the like.

If the viewer selects a specific data broadcast, various additional information can be displayed from the specific data broadcast.

If the viewer wants to view a different data broadcast besides the currently displayed data broadcast, the viewer can select and view the different data broadcast. Accordingly, the different data broadcasts from one another can be displayed on one screen.

If the different liked internet site exists among the currently displayed data broadcast contents, the viewer can select the different linked internet site (S46).

Accordingly, the viewer can move to the different linked internet site to search or view various additional information and the like provided from the corresponding internet site (S47).

For example, in case that an internet site for a specific actor's home page among descriptions for a specific actor is linked in the currently displayed data broadcast contents, the viewer can select the linked internet site to move to the specific actor's home page thereby obtaining more detailed information on the specific actor.

As described above, the present invention registers the digital broadcast or the data broadcast on the internet site, and connects to the internet site at the receiving unit to view the digital broadcast or the data broadcast. Therefore, the viewer can use the certain terminal allowing the internet connection to always view the digital broadcast or the data broadcast irrespective of a limit to time and place. Accordingly, more various data broadcast contents can be not only produced, but also the data broadcast is generalized in life by the viewers familiar to an internet environment to appear to give a great contribution to activation of the data broadcast.

Further, the present invention can use the internet terminal with the internet function to simply and conveniently view the digital broadcast or the data broadcast whileas the conventional art uses a high-priced settop box or digital television to receive the digital broadcast. Accordingly, the cost is greatly economically cut down while viewer's accessibility to the digital broadcast or the data broadcast can be more extended.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A digital broadcasting system comprising:
a transmitting means having a unit for generating digital broadcast including audio/video broadcast and data broadcast, and a unit for registering the digital broadcast or the data broadcast on a certain internet site; and
an internet terminal connecting to the internet site to receive the digital broadcast or the data broadcast.

2. The digital broadcasting system according to claim 1, wherein the data broadcast is produced based on Markup or Java.

3. The digital broadcasting system according to claim 1, wherein the internet terminal has a browser embedded therein for allowing connection to the internet site.

4. The digital broadcasting system according to claim 3, wherein the browser is any one of a widely used browser embedded in the internet terminal or a widely used browser provided from the internet site.

5. The digital broadcasting system according to claim 1, wherein the internet site stores the digital broadcast or the data broadcast continuously produced.

6. The digital broadcasting system according to claim 1, further comprising means for converting the digital broadcast and the data broadcast into an internet-supporting format in case that the digital broadcast or the data broadcast is not in the internet-supporting format.

7. The digital broadcasting system according to claim 1, wherein the internet terminal is one of a PDA, a mobile terminal, a widely used computer, a portable computer, home electric appliances with an internet function.

8. A method for operating digital broadcast at a transmitting unit of a digital broadcast system, the method comprising the steps of:
producing data broadcast;
generating the digital broadcast by using the data broadcast and audio/video broadcast; and
registering the produced data broadcast or the produced digital broadcast on a certain internet site,
wherein the produced data broadcast or the generated digital broadcast is provided depending on a viewer's request.

9. The method according to claim 8, wherein the internet site provides a viewer with a dedicated browser.

10. The method according to claim 8, wherein the internet site stores the digital broadcast or the data broadcast continuously produced.

11. The method according to claim 8, further comprising the step of converting the generated digital broadcast and the produced data broadcast into an internet-supporting format in case that the generated digital broadcast and the produced data broadcast is not in the internet-supporting format.

12. A method for operating digital broadcast at an internet terminal of a digital broadcasting system, the method comprising the steps of:
connecting to an internet site providing digital broadcast or data broadcast;
selecting broadcast that is intended to be viewed; and
downloading and displaying the selected broadcast.

13. The method according to claim 12, further comprising the step of downloading and installing a dedicated browser in case that the dedicated browser exists in the internet site.

14. The method according to claim 12, wherein one of the dedicated browser provided from the internet site or a widely used browser embedded in the internet terminal is used to connect to the internet site.

15. The method according to claim 12, wherein in case that a linked internet site exists among the displayed broadcasts, a viewer moves to the linked internet site depending on his/her request.

16. The method according to claim 12, wherein various data broadcasts provided from the internet site are concurrently displayed in addition to the displayed broadcast.

17. A method for operating a digital broadcasting system, the method comprising the steps of:
registering digital broadcast or data broadcast on a certain internet site;
connecting to the internet site to select broadcast that is intended to be viewed; and
downloading and displaying the selected broadcast.

18. The method according to claim 17, wherein the digital broadcast comprises audio/video broadcast and data broadcast.

19. The method according to claim 17, wherein the internet site has a plurality of digital broadcasts or data broadcasts continuously stored.

20. The method according to claim 17, wherein the data broadcast has a linked internet site.
